(19) United States
(12) Patent Application Publication
(10) Pub. No.: US 2013/0299299 A1
(43) Pub. Date: Nov. 14, 2013

(54) CLUTCH TO BE ACTUATED ELECTRICALLY

(71) Applicants: BERNHARD HOFFMANN, Starnberg (DE); ANDREAS GRUENDL, Starnberg (DE); REINHARD RASCH, Hechendorf (DE)

(72) Inventors: BERNHARD HOFFMANN, Starnberg (DE); ANDREAS GRUENDL, Starnberg (DE); REINHARD RASCH, Hechendorf (DE)

(73) Assignee: COMPACT DYNAMICS GMBH, Starnberg (DE)

(21) Appl. No.: 13/888,855

(22) Filed: May 7, 2013

(30) Foreign Application Priority Data
May 8, 2012 (DE) 10 2012 009 324.1

(51) Int. Cl. F16D 27/00

(52) U.S. Cl. CPC F16D 27/004
USPC 192/84.9

(57) ABSTRACT

A clutch has a stationary carrier, a first clutch member and a second clutch member. The first clutch member and the second clutch member are disposed so as to be rotatable about a common axis. The carrier has a coil arrangement, which is partially accommodated in a first partial core containing soft iron and which faces towards the first clutch member. The first clutch member has a second partial core, containing soft iron, having magnetic-flux poles that at least partially enclose the coil arrangement of the stationary carrier. The second clutch member has permanent-magnet elements, which face towards the magnetic-flux poles and which, are at least partially in alignment with at least some of the magnetic-flux poles. The first clutch member and the second clutch member are set up to transmit a torque and/or a rotary motion from the one clutch member to the other clutch member.

### BACKGROUND, PRIOR ART

Disclosed here is a clutch, to be actuated electrically, which has a first clutch member and a second clutch member. In the case of this clutch to be actuated electrically, a slip prevailing between the first and the second clutch member is influenced by means of control signals. Thus, a torque transmitted from one clutch member to the other clutch member can be varied, and/or the ratio of a rotational speed of the first clutch member to a rotational speed of the second clutch member can be set.

Clutches serve to establish a continuous or intermittent rotationally fixed connection of shafts, wheels or other drive elements, and in doing so, for example, they control forces and moments for the purpose of separating and connecting, i.e. switching, the drive elements, for the purpose of damping fluctuations of torque and speed.

The torque is transmitted frictionally, in dry operation, by electromagnetic clutches. In the case of electric clutches, transmission of moment is mostly effected without torsional play.

Unlike positive clutches, in the case of magnetic-field clutches the transmission of force is effected by means of magnetic fields. Owing to the relatively loose coupling between the drive and the output, the frictional connection between the drive and the output is lost if the maximally transmissible moment is exceeded.

The class of torsionally flexible clutches that do not compensate offset includes, for example, magnetic-powder clutches. Magnetic-powder clutches contain an iron powder, which serves to transmit the torque from an outer rotor to an inner rotor. The iron powder of the powder clutches forms magnetic chains, and thus transmits the torque from the outer to the inner rotor. The transmissible torque of the magnetic clutches is determined by the degree of electromagnetic excitation, allowing stepless variation of the transmitted torque, and noiseless actuation. The transmitted torque is proportional to the excitation current. The magnetic-powder clutches are suitable for continuous slip. They thus allow torque regulation or limitation, and are suitable as a smooth-operation starting clutch.

### OBJECT TO BE ACHIEVED

The aim is to provide a compactly constructed, highly efficient clutch that is to be actuated electrically.

### ACHIEVEMENT OF THE OBJECT

In order to achieve this aim, there is proposed here a clutch to be actuated electrically, having the features of Claim 1. In this case, the clutch to be actuated electrically has a stationary carrier, and has a first clutch member and a second clutch member. The first clutch member and the second clutch member are disposed so as to be rotatable, relative to the stationary carrier and relative to each other, about a common axis. The carrier has a coil arrangement, which is partially accommodated in a first partial core containing soft iron and which faces towards the first clutch member. The first clutch member has a second partial core, containing soft iron, having magnetic-flux poles that at least partially enclose the coil arrangement of the stationary carrier, together with the first partial core containing soft iron, in the radial direction, and that face towards the second clutch member. The second clutch member has permanent-magnet elements, which face towards the magnetic-flux poles and correspond to the latter, and which, at least in some positions of the second clutch member relative to the first clutch member, are at least partially in alignment with at least some of the magnetic-flux poles. The first clutch member and the second clutch member are set up to transmit a torque and/or a rotary motion from the one clutch member to the other clutch member, the coil arrangement being set up to be connected to an inverter, in order to influence the degree to which the torque and/or of the rotary motion are/is transmitted from the one clutch member to the other clutch member.

### ADVANTAGES, DESIGNS AND DEVELOPMENTS

An advantage of this arrangement is that the coil arrangement for excitation of the partial cores is stationary with the stationary carrier, i.e. it does not need rotating contact slipring arrangements or the like. This helps to make the overall arrangement easier to service.

The first partial core of the carrier and the second partial core of the first clutch member can be separated from each other by a first air gap. On its side that faces away from the first air gap, the second partial core of the first clutch member can be separated from the permanent-magnet elements of the second clutch member by a second air gap.

In this case, the first partial core of the carrier and the second partial core of the first clutch member can have mutually corresponding, rotationally symmetrical circumferential surfaces, which delimit the first air gap. The second partial core of the first clutch member and the permanent-magnet elements of the second clutch member can have mutually corresponding, rotationally symmetrical circumferential surfaces, which delimit the second air gap in the radial direction.

Permanent-magnet elements that are adjacent to each other in the direction of rotation of the second clutch member, i.e. that are disposed in a row along the circumference, can in each case be oriented towards the second air gap in a magnetically alternating manner. Moreover, a plurality of such rows can be provided in succession on the second clutch member, which rows are set up to act in combination with corresponding coil arrangements and with first and second partial cores.

The first clutch member can have a first coupling flange, and the second clutch member can have a second coupling flange.

The inverter can be connected to an electronic control device, which, through the frequency, phase and or the amount and the flow direction of the electrical power flowing between the inverter and the coil arrangement, influences the torque transmitted from the one clutch member to the other clutch member and/or the rotary motion. Thus, through supply of power to, or removal of power from, the coil arrangement, the degree of coupling between the two clutch members can be varied between approximately zero (corresponding to free-wheeling) and 100% (corresponding in effect approximately to a rigid, e.g. positive, direct coupling), by corresponding control of the inverter.

The first partial core of the carrier and the second partial core of the first clutch member can be made, as a single part or as multiple parts, from a sheet metal containing soft iron or from pressed, sintered pure iron powder or from powder containing iron.

The permanent-magnet elements can be formed from an AlNi or AlNiCo alloy, from barium ferrite or strontium ferrite, from permanently magnetic rare-earth alloy or, also, embedded in plastic binder.

The permanent-magnet elements can have a substantially rectangular shape and act in combination with a soft-iron return of the carrier. Furthermore, a so-called Halbach arrangement can be used for the permanent-magnet elements, whose directions of magnetization are turned relative to each other, by 90° in each case, in the direction of the longitudinal axis of the arrangement. As a result, the field lines on the side in whose direction the director of the field is turned move closer together, resulting in an increase in the magnetic flow density. On the opposite side, the field lines are less closely spaced than in the undisturbed magnet, and therefore the field is weakened even at a short distance, or it disappears completely, since north and south poles alternate in each case.

The coil arrangement can have a ring-cylindrical winding of stranded conductors having insulated individual conductors that are twisted or interlaced with each other; in the case of higher winding numbers, the coil arrangement can have a coiled individual conductor.

In order for the coil arrangement to be at least partially enclosed by the first partial core of the carrier, which contains soft iron, and the magnetic-flux poles of the first clutch member, magnetic-flux poles that are adjacent to each other can be spaced apart from each other and oriented in a offset manner in relation to each other. The magnetic-flux poles that are adjacent to each other can taper, coaxially in relation to the rotation axis, in alternating directions, and intermesh mutually in an offset manner.

The first clutch member and the second clutch member can be set up to be disposed in the drive train of a motor vehicle, between a crankshaft of an internal combustion engine and a (manual or automatic) transmission input, in order that, controlled by the feeding or tapping of electrical power through or into the inverter, they damp vibrations of the internal combustion engine and/or thereby tap electrical power into an electrical on-board network of the motor vehicle.

The first clutch member and the second clutch member can be connected to each other by a spring acting in/against the direction of rotation. The first clutch member and the second clutch member can be set up to assume any rotational angle, about the longitudinal axis, in relation to each other and, between the first clutch member and the second clutch member, a generator operating mode or a motor operating mode can be settable through corresponding control of the inverter by the electronic control device.

In generator operating mode, in the case of a relative rotational speed between the first clutch member and the second clutch member, a dynamo function can be implemented by the present clutch. In the case of a constant torque to be transmitted, the spring carries all of the torque in case; the clutch to be actuated electrically serves only to damp vibration in this case.

In motor operating mode, in the case of a relative rotational speed between the first clutch member and the second clutch member, a starter function (against an inhibited vehicle transmission, e.g. by the vehicle brake) can be implemented by the present clutch.

Finally a hybrid operating mode can also be implemented with the present clutch: electrical starting with the internal combustion engine inhibited and additional delivery of rotational speed during acceleration, as well as electrical recuperation of braking energy when the internal combustion engine is inhibited.

### BRIEF DESCRIPTION OF THE DRAWING

For persons skilled in the art, further features, characteristics, advantages and possible modifications are evident from the description that follows, in which reference is made to the appended drawings.

FIG. 1 is a schematic, longitudinal-section representation of a clutch of the type presented here.

FIG. 2 is a schematic, perspective portion of a second partial core.

The ratios of the individual parts, and portions thereof, in relation to each other that are shown in the figure, and the dimensions and proportions thereof, are to be understood as non-limiting. Rather, individual dimensions and proportions can also differ from those shown.

### DETAILED DESCRIPTION OF THE DRAWING

The figure shows a clutch 10 to be actuated electrically, which, in the variant shown here, has a stationary, tubular carrier 12, in which a first clutch member 14 and a second clutch member 16 are accommodated. The carrier 12 in this case encloses the clutch 10 and additionally has a housing wall 12a. The first clutch member 14 and the second clutch member 16 are disposed so as to be rotatable, about a common axis, relative to the stationary carrier 12 and relative to each other. A torque and/or a rotary motion can be transmitted from the one clutch member 14, 16 to the other clutch member 16, 14 in a manner explained in detail further below.

The carrier 12 has a coil arrangement 18, which is partially accommodated in a first partial core 12b, which contains soft iron. For this purpose, the tubular carrier 12, on the inside of its housing wall 12a, carries a stack of annular discs made from a sheet metal containing soft iron. In an alternative embodiment, instead of the sheet-metal stack composed of soft iron and the carrier, these components are made of a sintered metal composite—SMC—material. Provided in this sheet-metal stack there are ring-cylindrical recesses, which are open towards the inside and in which, respectively, a coil arrangement 18 is accommodated. The sheet-metal stack therefore in each case encloses a coil arrangement 18 in an approximately U-shaped manner, such that each coil arrangement 18, separated by a first ring-cylindrical air gap 20, faces with its free inside surface towards the first clutch member 14.

The first clutch member 14 has a second partial core 14b, containing soft iron, having magnetic-flux poles 14c (see also FIG. 2), which enclose, in the radial direction, the coil arrangement 18 of the stationary carrier 12, together with the first partial core 12b containing soft iron. In the variant shown, the second partial core 14b of the first clutch member 14 is made, as multiple parts, from pressed, sintered pure iron powder or SMC material. On the inside of the first clutch member 14, the magnetic-flux poles 14c face towards the second clutch member 16. In this case, a second ring-cylindrical air gap 22 is formed between the first clutch member 14 and the second clutch member 16.

The second clutch member 16 has permanent-magnet elements N, S, which face towards the magnetic-flux poles 14c of the first clutch member 14 and correspond to these poles, and which, in some (rotary) positions of the second clutch member 16 relative to the first clutch member 14, are in alignment with all or almost all of the magnetic-flux poles 14c. The permanent-magnet elements N, S are made of a magnetic material (for example, of an SmCo or NdFeB alloy), have a substantially rectangular shape and are embedded in a magnetically non-active carrying tube 16c. The magnetic orientation of permanent-magnet elements N, S of the second clutch member 16 that are adjacent to each other alternates in each case towards the air gap 16. The several rows of adjacent permanent-magnet elements N, S in the circumferential direction of the second clutch member 16 result here in a pattern of alternating magnetic orientation, with permanent-magnet elements N, S displaced in relation to each other, in the circumferential direction, by the electrical phase position of the corresponding coil arrangements.

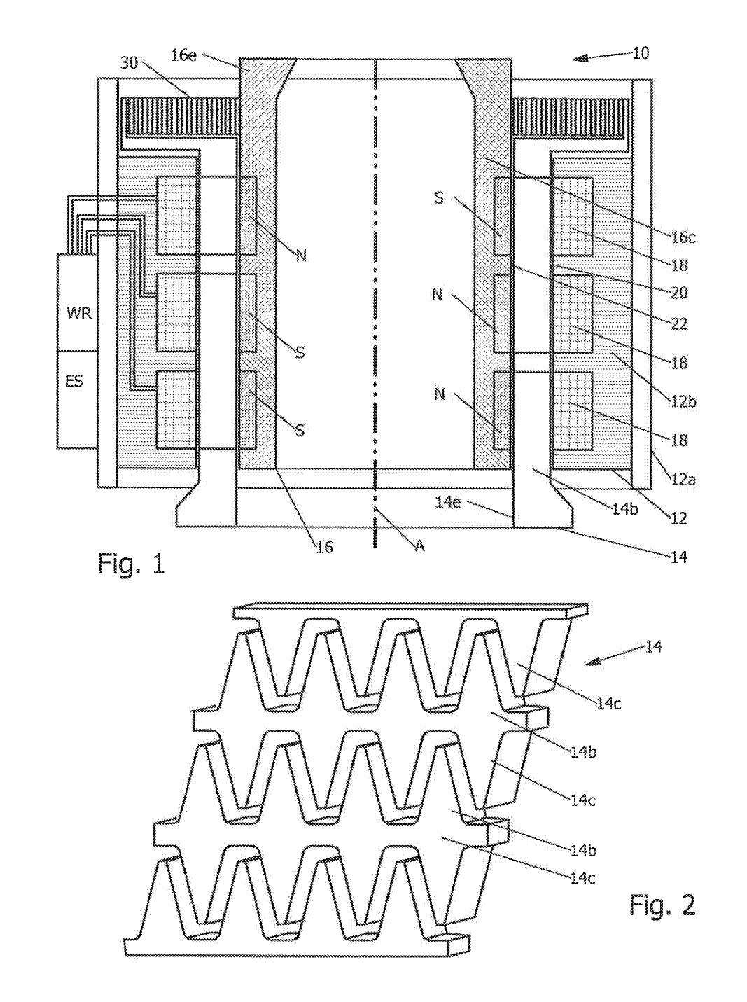

The first clutch member 14 has a first coupling flange 14e at one end (the lower end in FIG. 1), and the second clutch member 16 has a second coupling flange 16e at one end (the upper end in FIG. 1).

The coil arrangement 18 is connected to an inverter WR, in order to influence the degree to which the torque and/or the rotary motion are/is transmitted from the one clutch member to the other clutch member. The inverter WR is connected to an electronic control device ES, in order to influence, through the frequency, phase, amount and/or the flow direction of the electrical power flowing between the inverter WR and the coil arrangement 18, the torque transmitted from the one clutch member to the other clutch member and/or the rotary motion.

The magnetic-flux poles 14c of the second partial core 14b containing soft iron are spaced apart from each other to such an extent, and oriented alternately, that they intermesh mutually in a finger-like or claw-like manner and thus encompass the coil arrangement 18 on their inside and enclose it together with the first partial core 12b containing soft iron. Magnetic-flux poles 14c that are adjacent to each other in the circumferential direction taper, coaxially in relation to the rotation axis, in alternating directions, and intermesh mutually in an offset manner.

The coil arrangement 18 is wound, as a ring-cylindrical coil of stranded conductors, consisting of varnish-insulated individual conductors that are twisted together or interlaced, or of individual conductors, in a coil body made of plastic. The coil body has a connection channel, which extends from the outside of the coil body as far as the inverter WR outside the clutch. Stranded conductors, consisting of varnish-insulated individual conductors that are twisted together or interlaced, can be used to form the coil arrangement 18. This counteracts the increase in the conductor resistance at higher frequencies. Eddy currents, which counteract the current flow, occur in an electrical conductor as a result of magnetic fields of the alternating current. These eddy currents increase at higher frequencies. Accordingly, an alternating-current equivalent resistance, which is dependent on the frequency, is added to the direct-current resistance. In order to keep the aforementioned losses as small as possible, the conductor cross-section is reduced, which results in lesser eddy-current losses and for this purpose routes a plurality of conductors parallelwise. In order to balance out the current asymmetry of the individual conductors, the conductors are twisted or stranded together.

The individual-conductor cross-section of the coil arrangement 18 should decrease as the frequency increases; in the range around 1 kHz, the individual-conductor cross-section should be approximately 0.4 mm. In order to improve the fullness factor (volume of the winding space relative to the volume of the electrical conductor), stranded conductors having a rectangular profile are preferably used. The fullness factor gain results from the stranded conductor having been rendered more compact, the better filling of the winding space as a result of the rectangular geometry. The individual conductors can have one or more spun coverings/braidings of various yarns, e.g. polyamide, cotton, glass, polyester, aramide, etc. It is also possible to use one or more bandings of polyester films, polyimide films, aramide paper, glass bands, etc. Insulations composed of adhesive-coated films such as polyester and polyimide are heat-treated, in order to achieve an insulation with good adhesive bonding. Combinations of the aforementioned measures can likewise be used. Instead of the stranded conductors, a solid copper conductor, composed of a copper band, can constitute the winding. In this case, likewise, the conductor can be twisted. The copper band should be thin.

The first clutch member and the second clutch member are disposed, for example,—in a drive train of a motor vehicle, not illustrated further—between a crankshaft of an internal combustion engine and a transmission input, in order that, controlled by the feeding or tapping of electrical power through or into the inverter WR, they damp vibrations of the internal combustion engine and/or thereby tap electrical power into an electrical on-board network of the motor vehicle.

The first clutch member 14 and the second clutch member 16 connected to each other by a spring energy store 30, realized as a spiral spring. In this case, the outer and the inner end of the spiral spring are each fixedly connected to the first clutch member 14 and the second clutch member 16, respectively. This allows a—limited—relative rotation between the first clutch member 14 and the second clutch member 16, and allows the static torque to be transmitted via the spring 30.

In another variant, the first clutch member 14 and the second clutch member 16 are set up to assume any rotary angle in relation to each other. This is achieved through omission of the spring energy store 30. In this case, a generator operating mode or a motor operating mode can be set between the first clutch member 14 and the second clutch member 16, through corresponding control of the inverter by the electronic control device.

There is thus provided, in the drive train of the motor vehicle, an arrangement in which the spring arrangement is located the between the crankshaft and transmission input, and can absorb rotational vibrations. Disposed parallelwise in relation to the spring arrangement, i.e. bridging the latter, is the clutch described here. In this case, for example, the crankshaft is connected in a rotationally fixed manner to the clutch member that carries the permanent magnets, and the input shaft of a transmission is connected in a rotationally fixed manner to the other other clutch member. The carrier having the coil arrangement is stationary, and is fed via an inverter. The device can damp vibrations and can thereby also tap electrical power into the electrical on-board network of the motor vehicle.

If the static torque to be transmitted is too great, also possible—without the spring—are (i) a generator operating mode, in the manner of a dynamo, in the case of a relative rotational speed between the crankshaft and the transmission input, (ii) a motor operating mode, in the manner of a starter, for example against an inhibited transmission, e.g. by means of a brake, and (iii) a hybrid operating mode, with electrical starting with the internal combustion inhibited and an additional feed-in of torque during acceleration of the motor vehicle.

The variants of the clutch that have been described above serve only to aid understanding of the structure, method of functioning and the characteristics; they do not limit the disclosure to, for instance, the embodiments. The figures are schematic, wherein essential characteristics and effects are in some cases represented in a significantly enlarged form in order to illustrate the functions, operating principles, technical designs and features.

In this case, each method of functioning disclosed in the figure or the text, each principle, each technical design and each feature can be freely and optionally combined with all claims, each feature in the text and in the other figure, other methods of functioning, principles, technical designs and features that are contained in this disclosure or that ensue therefrom, such that all conceivable combinations of the described clutch are ascribable. Also included in this case are combinations between all individual statements in the text, i.e. in each portion of the description, in the claims and also combinations between differing variants in the text, in the claims and in the figures.

Moreover, the claims do not limit the disclosure and therefore the possibilities for combining all indicated features with each other. Here, all indicated features are also explicitly disclosed singly and in combination with all other features.

What is claimed:

1) Clutch to be actuated electrically, having
a stationary carrier, and a first clutch member and a second clutch member, wherein
the first clutch member and the second clutch member are disposed so as to be rotatable, relative to the stationary carrier and relative to each other, about a common axis, and are set up to transmit a torque and/or a rotary motion from the one clutch member to the other clutch member,
the carrier has a coil arrangement, which is partially accommodated in a first partial core containing soft iron and which faces towards the first clutch member,
the first clutch member has a second partial core, containing soft iron, having magnetic-flux poles that at least partially enclose the coil arrangement of the stationary carrier, together with the first partial core containing soft iron, in the radial direction, and that face towards the second clutch member,
the second clutch member has permanent-magnet elements (N, S), which face towards the magnetic-flux poles and correspond to the latter, and which, at least in some positions of the second clutch member relative to the first clutch member, are at least partially in alignment with at least some of the magnetic-flux poles (N, S), wherein
the first clutch member and the second clutch member are set up to transmit a torque and/or a rotary motion from the one clutch member to the other clutch member, and the coil arrangement is set up to be connected to an inverter (WR), in order to influence the degree to which the torque and/or of the rotary motion are/is transmitted from the one clutch member to the other clutch member.

2) The clutch to be actuated electrically according to claim 1, wherein
the first partial core of the carrier and the second partial core of the first clutch member are separated from each other by a first air gap, and/or
on its side that faces away from the first air gap, the second partial core of the first clutch member is separated from the permanent-magnet elements (N, S) of the second clutch member by a second air gap.

3) The clutch to be actuated electrically according to claim 1, wherein
the first partial core of the carrier and the second partial core of the first clutch member have mutually corresponding, rotationally symmetrical circumferential surfaces, which delimit the first air gap.

4) The clutch to be actuated electrically according to claim 1, wherein
the second partial core of the first clutch member and the permanent-magnet elements (N, S) of the second clutch member have mutually corresponding, rotationally symmetrical circumferential surfaces, which delimit the second air gap.

5) The clutch to be actuated electrically according to claim 1, wherein
permanent-magnet elements (N, S) that are adjacent to each other in the direction of rotation of the second clutch member are in each case oriented towards the second air gap in a magnetically alternating manner.

6) The clutch to be actuated electrically according to claim 1, wherein
the first clutch member has a first coupling flange and/or
the second clutch member has a second coupling flange.

7) The clutch to be actuated electrically according to claim 1, wherein
the inverter (WR) is connected to an electronic control device (ES), which, through the frequency, phase, amount and/or the flow direction of the electrical power flowing between the inverter (WR) and the coil arrangement, influences the torque transmitted from the one clutch member to the other clutch member and/or the rotary motion.

8) The clutch to be actuated electrically according to claim 1, wherein
the first partial core of the carrier and/or the second partial core of the first clutch member are made, as a single part or as multiple parts, from a sheet metal containing soft iron or from pressed, sintered pure iron powder or from powder containing iron.

9) The clutch to be actuated electrically according to claim 1, wherein
the permanent-magnet elements (N, S) have a substantially rectangular shape, and/or are disposed in a Halbach arrangement on the circumference of the carrier.

10) The clutch to be actuated electrically according to claim 1, wherein
the first clutch member and the second clutch member are connected to each other by a spring energy store.
